(19) United States
(12) Patent Application Publication
(10) Pub. No.: US 2017/0371158 A1
(43) Pub. Date: Dec. 28, 2017

(54) COMPACT PIVOT SYSTEM FOR M1 MIRROR IN HEAD UP DISPLAY (HUD) RESULTING IN REDUCED FRICTION AND ACCURATE MIRROR TO MIRROR LOCATION

(71) Applicant: Panasonic Automotive Systems Company of America, Division of Panasonic Corporation of North America, Peachtree City, GA (US)

(72) Inventor: GERALD A. TANG-KONG, NEWNAN, GA (US)

(73) Assignee: Panasonic Automotive Systems Company of America, Division of Panasonic Corporation of North America

(21) Appl. No.: 15/620,966

(22) Filed: Jun. 13, 2017

Related U.S. Application Data
(60) Provisional application No. 62/354,607, filed on Jun. 24, 2016.

(51) Int. Cl. G02B 27/01; G02B 5/10

(52) U.S. Cl. CPC G02B 27/0149; G02B 27/0101; G02B 5/10; G02B 2027/0154

(57) ABSTRACT

A head up display mirror mounting arrangement for a motor vehicle includes a mirror positioned to reflect an image such that the image is again reflected by a windshield of the vehicle. A mirror holder includes two opposite ends each having a respective pivot. The pivots define an axis of rotation of the mirror. The mirror holder holds the mirror. A housing includes two opposite ends each having a respective bearing support. Two rotation mechanisms each pivotably couple a respective pivot to a respective bearing support.

### CROSS-REFERENCED TO RELATED APPLICATIONS

This application claims benefit of U.S. Provisional Application No. 62/354,607 filed on Jun. 24, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield.

Conventional head op displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

The use of two free form mirrors in a HUD results in the smallest distance between the mirrors, and hence the smallest package size. However, accurate location of the mirrors with respect to each other is required to minimize distortion. This is achieved by having each mirror and its holder mounted directly to mounting features that are molded into the plastic lower housing. These molded features can be held accurately to each other since they are done in the same tool. Not having a separate M1 mirror holder/mirror mounting bracket introduces additional tolerance stack-ups which results in mirror to mirror distance variation and introduces image distortions reducing virtual image quality. Existing designs use sub-assemblies or brackets which are not accurate. Accurate and consistent mirror locations are required when using two free form mirrors.

### SUMMARY

The present invention may provide a mounting system for the main free form mirror (M1) in a head up display utilizing two free form mirrors. The present invention also results in the smallest package width possible since there is no separate bracket and motor on the side of the bracket.

In one embodiment, the invention comprises a head up display mirror mounting arrangement for a motor vehicle, including a mirror positioned to reflect an image such that the image is again reflected by a windshield of the vehicle. A mirror holder includes two opposite ends each having a respective pivot. The pivots define an axis of rotation of the mirror. The mirror holder holds the mirror. A housing includes two opposite ends each having a respective bearing support. Two rotation mechanisms each pivotally couple a respective pivot to a respective bearing support.

In another embodiment, the invention comprises a head up display method for a motor vehicle, including emitting a light field based on image data. The light field is reflected with a mirror such that the light field further reflects off of a windshield of the motor vehicle and is visible to a driver of the vehicle as a virtual image. The mirror is held with a mirror holder having two opposite ends each having a respective pivot. The pivots define an axis of rotation of the mirror. A housing is provided including two opposite ends each having a respective bearing support. Each pivot is pivotably coupled to a respective bearing support.

In yet another embodiment, the invention comprises a head up display mirror mounting arrangement for a motor vehicle, including an image source emitting a light field. A mirror is positioned to reflect the light field such that the light field is again reflected by a windshield of the vehicle. A mirror holder assembly has two opposite ends each having a respective bearing. The bearings define an axis of rotation of the mirror. The mirror holder assembly holds the mirror. A housing includes two opposite ends each having a respective bearing support. Each bearing support is pivotably coupled to a respective bearing.

### BRIEF DESCRIPTION OF THE DRAWINGS

A better understanding of the present invention will be had upon reference to the following description in conjunction with the accompanying drawings.

FIG. 1 is a perspective view of one example embodiment of a compact pivot system for a M1 mirror in a HUD of the present invention.

FIG. 2 is an exploded, perspective view of the compact pivot system of FIG. 1.

FIG. 3 is an enlarged view of area A in FIG. 2.

FIG. 4 is a perspective view of another example embodiment of a compact pivot system for a M1 mirror in a HUD of the present invention.

FIG. 5 is an exploded, perspective view of the compact pivot system of FIG. 4.

FIG. 6 is an enlarged view of area A in FIG. 5.

FIG. 7 is a flow chart of one embodiment of a head up display method of the present invention for a motor vehicle.

### DETAILED DESCRIPTION OF THE PREFERRED EMBODIMENTS

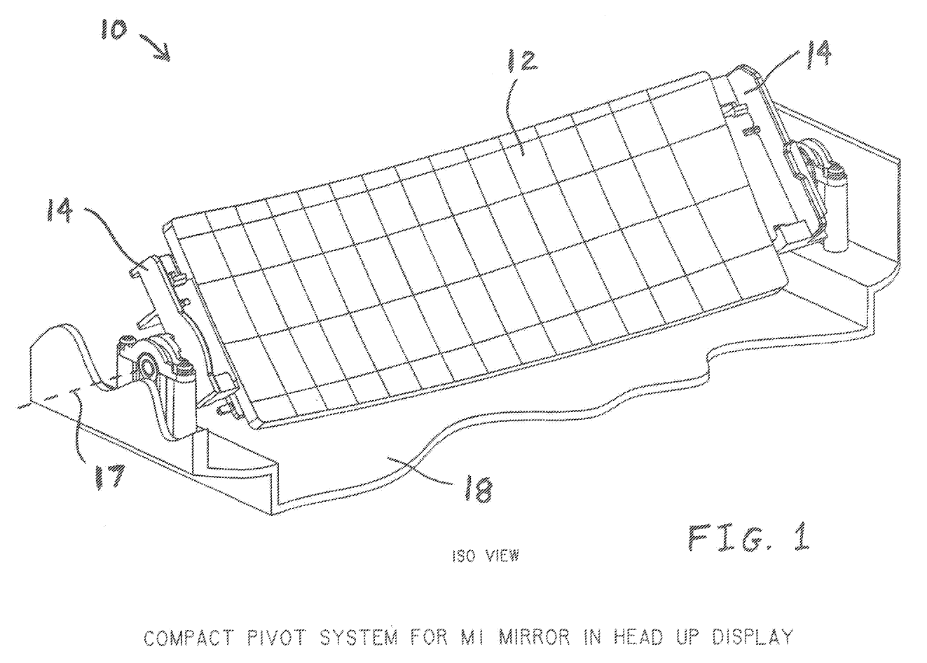

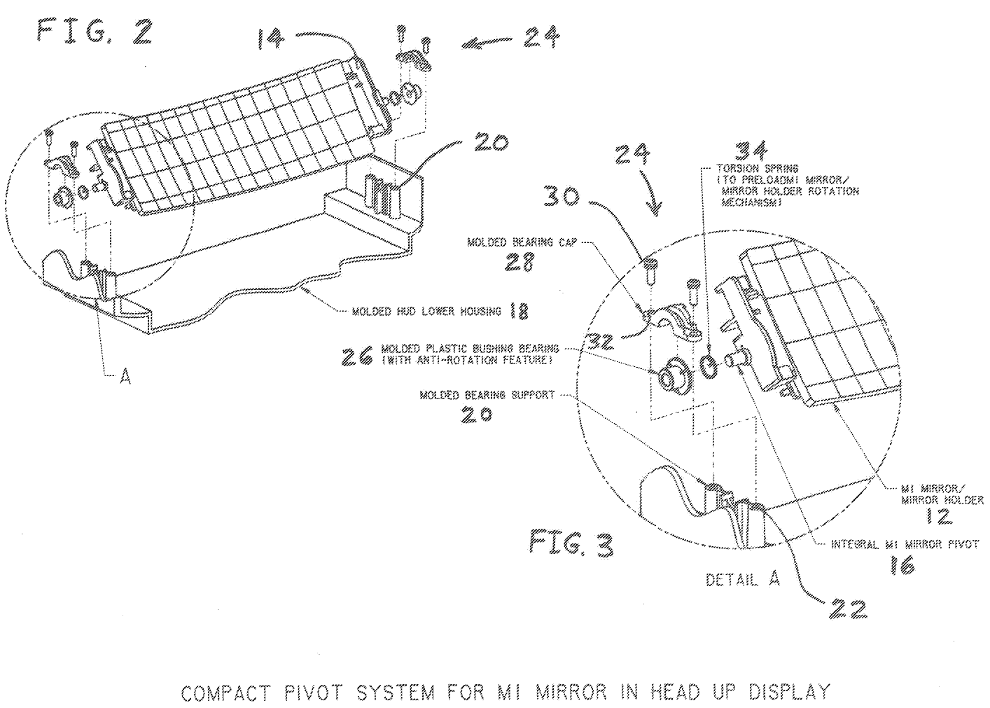

FIG. 1 illustrates one example embodiment of a compact pivot system 10 for a M1 mirror 12 in a HUD of the present invention. Mirror 12 is mounted in a mirror holder 14 having two opposing integral pivots 16 (FIG. 3). Pivots 16 define an axis of rotation 17 of mirror 12. Mirror holder 14 is attached to a molded HUD lower housing 18 having two molded bearing supports 20 having internally threaded screw holes 22.

Mirror holder 14 is coupled to housing 18 via two mirror holder rotation mechanisms 24, each including a molded plastic hushing bearing 26 having an anti-rotation feature. Each bearing 26 is received in a respective bearing support 20, and the anti-rotation features may limit the range of rotation of bearing 26 relative to bearing support 20 by abutting bearing support 20 at the ends of the rotation range. Two molded bearing caps 28 each secure a respective bearing 26 to a respective bearing support 20 via threaded screws 30 received through throughholes 32 in caps 28, and received in screw holes 22.

Two torsion springs 34, each received on a respective pivot 16, may preload mirror 12 and mirror holder rotation mechanism 24. Using a torsion spring 34 at each pivot 16 to preload the M1 mirror holder/mirror may make assembly easier because torsion spring 34 may be installed at the same time as mirror 12 and bushing bearing 26. Mirror holder 14, mirror holder rotation mechanisms 24, and torsion springs 34 may be conjunctively referred to herein as a “mirror holder assembly.”

Bushing bearings 26 may be of the low friction variety in order to reduce friction between mirror holder pivots 16 and housing 18. Housing 18 and mirror holder 14 may be made of glass filled materials which are abrasive and have high friction characteristics in order to inhibit jerky movement and vibration of mirror 12. A metal bracket 14 could not be made to tight tolerances, and the mounting to housing 18 may add to the variability of the M1 mirror holder/mirror location.

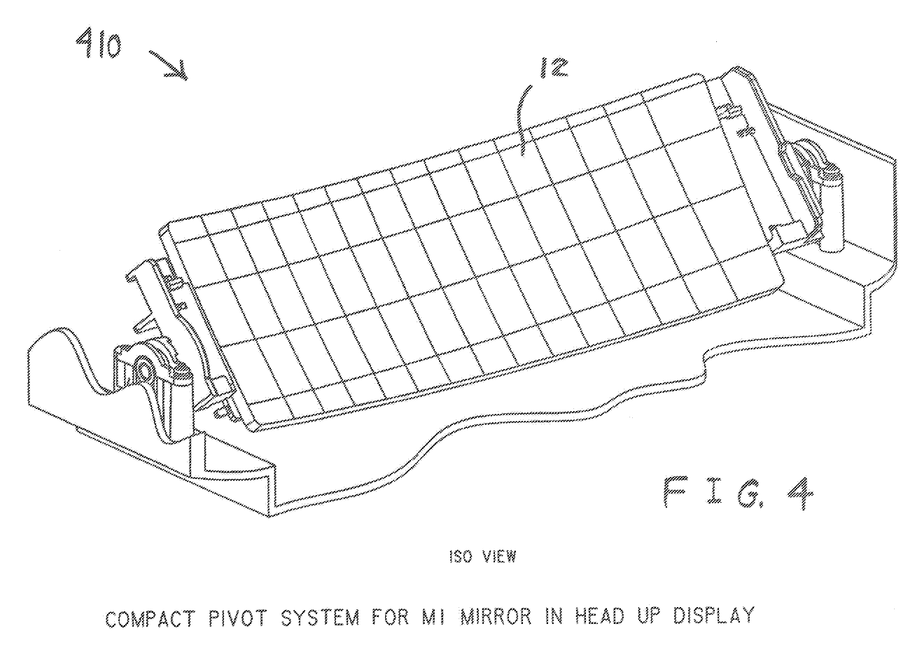

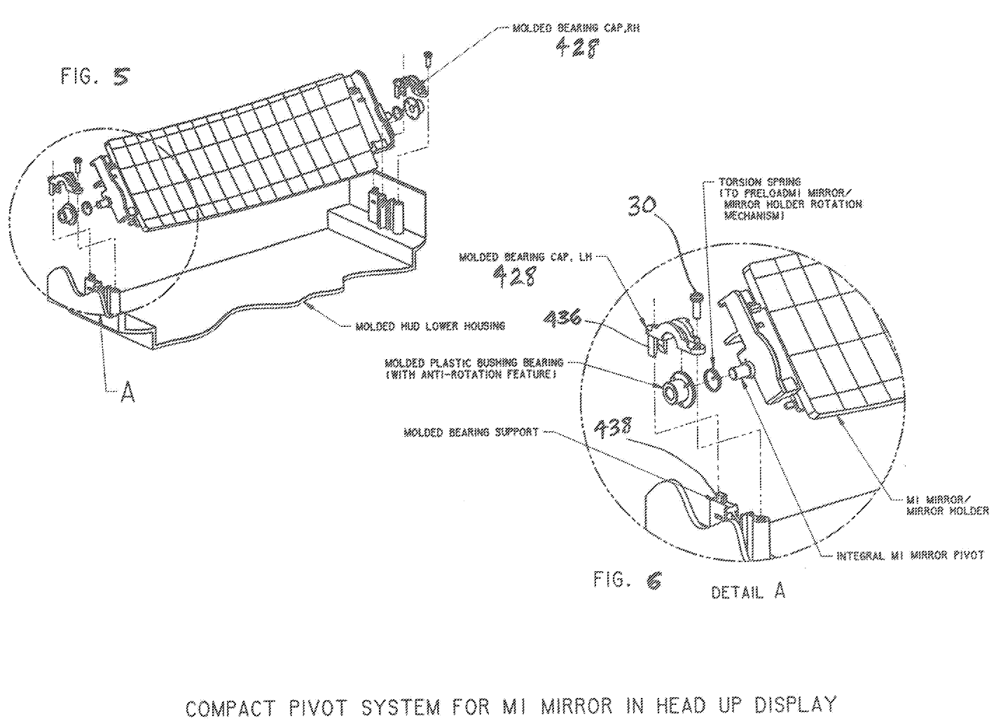

FIG. 4 illustrates another example embodiment of a compact pivot system 410 for a M1 mirror 12 in a HUD of the present invention. Compact pivot system 410 is substantially similar to compact pivot system 10, except that each molded bearing cap 428 (FIG. 5) is retained with a female snap connector 436 (FIG. 6), a male snap connector 438, and a screw 30, whereas compact pivot system 10 includes two screws 30 to retain each bearing cap 28.

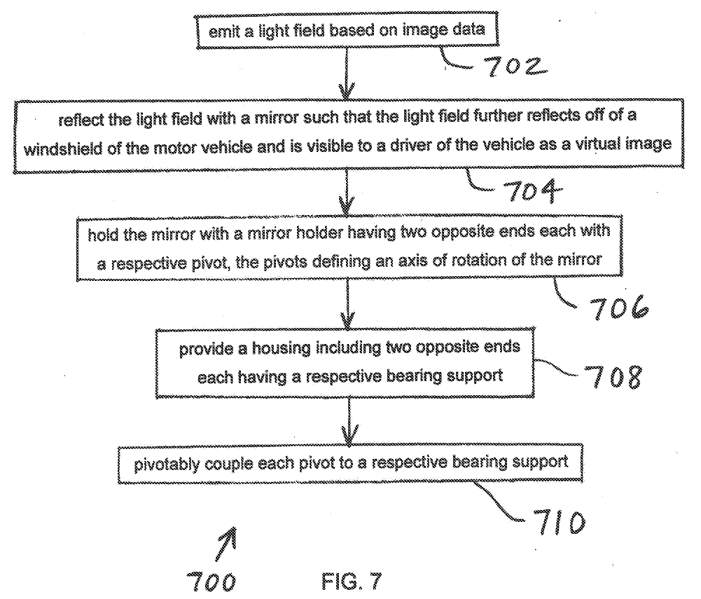

FIG. 7 illustrates one embodiment of a head up display method 700 of the present invention for a motor vehicle. In a first step 702, a light field is emitted based on image data. For example, a head up display controller may control a light field emitted by a light projector, wherein the controlling is based upon image data corresponding to information to be presented (e.g., a current speed of the motor vehicle).

Next, in step 704, the light field is reflected with a mirror such that the light field further reflects off of a windshield of the motor vehicle and is visible to a driver of the vehicle as a virtual image. For example, the light field may be reflected off of mirror 12 and further reflected off of the windshield of the vehicle such that the light field appears to the driver to be a virtual image disposed outside the windshield.

In a next step 706, the mirror is held with a mirror holder having two opposite ends each having a respective pivot. The pivots define an axis of rotation of the mirror. For example, mirror 12 may be held by a mirror holder 14 having two opposing integral pivots 16. Pivots 16 define an axis of rotation 17 of mirror 12.

In step 708, a housing is provided including two opposite ends each having a respective bearing support. For example, mirror holder 14 is attached to a molded HUD lower housing 18 having two molded bearing supports 20 at opposite ends.

In a final step 710, each pivot is pivotably coupled to a respective bearing support. For example, each pivot 16 of a mirror holder 14 is coupled to housing 18 via two mirror holder rotation mechanisms 24, each including a molded plastic bushing bearing 26. Each bearing 26 is received in a respective bearing support 20.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display mirror mounting arrangement for a motor vehicle, the arrangement comprising:
a mirror positioned to reflect an image such that the image is again reflected by a windshield of the vehicle;
a mirror holder having two opposite ends each having a respective pivot, the pivots defining an axis of rotation of the mirror, the mirror holder being configured to hold the mirror;
a housing including two opposite ends each having a respective bearing support; and
two rotation mechanisms each pivotably coupling a respective said pivot to a respective said bearing support.

2. The head up display mirror mounting arrangement of claim 1 wherein each said rotation mechanism includes a respective one of two bearings, each said bearing being received in a respective said bearing support.

3. The head up display mirror mounting arrangement of claim 2 wherein each said rotation mechanism includes a respective one of two bearing caps, each said bearing being retained between the respective bearing support and the respective bearing cap.

4. The head up display mirror mounting arrangement of claim 3 further comprising two torsion springs, each said torsion spring being disposed between a respective said pivot and a respective said bearing.

5. The head up display mirror mounting arrangement of claim 3 wherein each said bearing cap is secured to a respective said bearing support by a respective pair of screws.

6. The head up display mirror mounting arrangement of claim 2 wherein each said bearing includes a respective anti-rotation feature.

7. The head up display mirror mounting arrangement of claim 1 wherein the two pivots define, and are coincident with, a rotational axis of the mirror.

8. A head up display method for a motor vehicle, the method comprising:
emitting a light field based on image data;
reflecting the light field with a mirror such that the light field further reflects off of a windshield of the motor vehicle and is visible to a driver of the vehicle as a virtual image;
holding the mirror with a mirror holder having two opposite ends each having a respective pivot, the pivots defining an axis of rotation of the mirror;
providing a housing including two opposite ends each having a respective bearing support; and
pivotably coupling each said pivot to a respective said bearing support.

9. The head up display method of claim 8 wherein the pivotably coupling step includes receiving each said pivot in a respective bearing, each said bearing being received in a respective said bearing support.

10. The head up display method of claim 9 wherein the pivotably coupling step includes retaining each said bearing between the respective bearing support and a respective one of two bearing caps.

11. The head up display method of claim 10 wherein the pivotably coupling step includes placing each of two torsion springs between a respective said pivot and a respective said bearing.

12. The head up display method of claim 10 wherein the pivotably coupling step includes securing each said bearing cap to a respective said bearing support by a respective pair of screws.

13. The head up display method of claim 9 further comprising rotating the mirror until an anti-rotation feature of at least one said bearing engages said respective bearing support.

14. The head up display method of claim 8 wherein the two pivots define, and are coincident with, a rotational axis of the mirror.

15. A head up display mirror mounting arrangement for a motor vehicle, the arrangement comprising:
an image source configured to emit a light field;
a mirror positioned to reflect the light field such that the light field is again reflected by a windshield of the vehicle;
a mirror holder assembly having two opposite ends each having a respective bearing, the bearings defining an axis of rotation of the mirror, the mirror holder assembly being configured to hold the mirror; and
a housing including two opposite ends each having a respective bearing support, each said hearing support being pivotally coupled to a respective said bearing.

16. The head up display mirror mounting arrangement of claim 15 wherein said mirror holder assembly includes two torsion springs, each said torsion spring engaging a respective said bearing.

17. The head up display mirror mounting arrangement of claim 15 wherein said mirror holder assembly includes two bearing caps, each said hearing being retained between the respective bearing support and a respective one of the hearing caps.

18. The head up display mirror mounting arrangement of claim 17 wherein each said bearing cap is secured to a respective said hearing support by a respective pair of screws.

19. The head up display mirror mounting arrangement of claim 15 wherein each said bearing includes a respective anti-rotation feature.

20. The head up display mirror mounting arrangement of claim 15 wherein the mirror holder assembly includes two pivots, each said pivot being received in a respective said bearing.
